(19) United States
(12) Patent Application Publication
(10) Pub. No.: US 2015/0161440 A1
(43) Pub. Date: Jun. 11, 2015

(54) METHOD AND APPARATUS FOR MAP ALIGNMENT IN A MULTI-LEVEL ENVIRONMENT/VENUE

(71) Applicant: QUALCOMM Incorporated, San Diego, CA (US)

(72) Inventors: Hui Chao, San Jose, CA (US); Jiajian Chen, San Jose, CA (US); Yin Chen, Campbell, CA (US)

(73) Assignee: QUALCOMM Incorporated, San Diego, CA (US)

(21) Appl. No.: 14/103,770

(22) Filed: Dec. 11, 2013

(51) Int. Cl. G06K 9/00

(52) U.S. Cl. CPC G06K 9/00476; G06K 2009/00489

(57) ABSTRACT

Methods and devices are described for aligning map data from different levels of the same location/venue/environment. Certain embodiments may include receiving, at a computing device, first and second sets of map data associated with corresponding first and second levels of a location. The device may receive via a network or user interface, sets of anchor points matched across the different levels. These matched anchor points may then be used to deform one or more levels of map data to align any misaligned anchor points.

### BACKGROUND

Aspects of the disclosure relate to electronic maps, and particularly to collecting information related to the alignment of different levels and correcting alignment of different levels for multi-level maps.

Large area mapping systems showing streets, cities, and large areas that are common on smartphones typically deal only with single-level, two-dimensional maps, commonly showing a top-down satellite level view. As maps and location services for indoor and smaller areas become more common, the need to integrate multi-level maps into map systems becomes important.

For multi-level buildings, environments, or venues such as a shopping mall, floor maps for each level are usually created separately with GPS data, AP-based location data, known floor plan information, etc. When maps are aggregated to create a multi-level view, the separate levels may be misaligned due to small errors or scaling issues. Such misalignments may cause errors for indoor navigation across levels in a multi-level environment. Improved systems and methods for aligning maps in a multi-level environment may thus be desirable.

### BRIEF SUMMARY

Embodiments described herein include systems, methods, devices, and computer-readable media for map alignment to provide better positioning in navigation in multi-level venues.

One potential embodiment is a method for map alignment comprising: receiving, at a computing device, a first set of map data associated with a first level of a location; receiving, at the computing device, a second set of map data associated with a second level of the location; receiving, at the computing device, a first plurality of anchor markers for the first level and a second plurality of anchor markers for the second level, wherein each anchor point of the first plurality of anchor markers is associated with a corresponding anchor point of the second plurality of anchor markers for the second level; and deforming at least a portion of the first set of map data or the second set of map data to align anchor markers of the first plurality of anchor markers with corresponding anchor markers of the second plurality of anchor markers.

Additional embodiments of such a method may further operate where deforming at least the portion of the first set of map data or the second set of map data comprises: (a) moving the first plurality of anchor markers to new positions; and (b) moving data points in the portion of the first set of map data according to a moving least square (MLS) criterion, given new positions of the anchor markers of the first plurality of anchor markers.

Additional embodiments of such a method may further operate where deforming at least the portion of the first set of map data or the second set of map data comprises: (a) moving each anchor point of the first plurality of anchor markers a portion of a distance from an initial position to a position matching the corresponding anchor point of the second plurality of anchor markers; and (b) moving data points in the portion of the first set of map data according to a simplex constraint criterion, wherein the moving of each anchor point and the moving data points are jointly optimized to maximize the portion of the distance from the initial position to the position matching the corresponding anchor point and to minimize the moving of data points in the portion of the first set of map data.

Additional embodiments of such a method may further include calculating a deformation score that characterizes the deformation associated with aligning the anchor markers of the first plurality of anchor markers with the corresponding anchor markers of the second plurality of anchor markers. Additional embodiments of such a method may further include rejecting the deformation when the deformation score is beyond a predefined threshold. Still further embodiments may include adjusting the deformation to reduce the deformation score while maintaining at least a portion of the alignment when the deformation score is above a predefined threshold.

Additional embodiments of such a method may further operate where receiving the first plurality of anchor markers for the first level and the second plurality of anchor markers for the second level comprises: presenting an image of the first level to a user on a display of the computing device; receiving a user input identifying a first anchor point on the first level; presenting an image of the second level to the user on the display of the computing device; and receiving a user input identifying a second anchor point on the first level that corresponds to the first anchor point.

Additional embodiments of such a method may further operate where receiving the first plurality of anchor markers for the first level and the second plurality of anchor markers for the second level comprises: receiving at least one matched pair of first level and second level anchor points from a map management module of each mobile device of a plurality of crowdsourced mobile devices. Additional embodiments of such a method may further operate where the anchor markers comprise anchor points. Still further embodiments may function where the anchor markers further comprise anchor lines.

Another embodiment may be a computing device with functionality for map alignment comprising: a memory; and a processor coupled to the memory that executes instructions from the memory to: receive a first set of map data associated with a first level of a location; receive a second set of map data associated with a second level of the location; receive a first plurality of anchor markers for the first level and a second plurality of anchor markers for the second level, wherein each anchor point of the first plurality of anchor markers is associated with a corresponding anchor point of the second plurality of anchor markers for the second level; and deform at least a portion of the first set of map data or the second set of map data to align anchor markers of the first plurality of anchor markers with corresponding anchor markers of the second plurality of anchor markers.

Additional embodiments of such a computing device may function where deforming at least a portion of the first set of map data or the second set of map data comprises: (a) moving the anchor markers of the first plurality of anchor markers to new positions; and (b) moving data points in the portion of the first set of map data according to a moving least square (MLS) criterion, given new positions of the anchor markers of the first plurality of anchor markers.

Additional embodiments of such a computing device may function where deforming at least a portion of the first set of map data or the second set of map data comprises: (a) moving each anchor point of the first plurality of anchor markers a portion of a distance from an initial position to a position matching the corresponding anchor point of the second plurality of anchor markers; and (b) moving data points in the portion of the first set of map data according to a simplex constraint criteria, wherein the moving each anchor point and the moving data points are jointly optimized to maximize the portion of the distance from the initial position to the position matching the corresponding anchor point and to minimize the moving of data points in the portion of the first set of map data.

Additional embodiments of such a computing device may function where the processor further calculates a deformation score that characterizes the deformation associated with aligning the anchor markers of the first plurality of anchor markers with the corresponding anchor markers of the second plurality of anchor markers. Additional embodiments of such a computing device may function where the processor further acts in rejecting the deformation when the deformation score is beyond a predefined threshold.

Another embodiment may be a computing device comprising means for receiving a first set of map data associated with a first level of a location; means for receiving a second set of map data associated with a second level of the location; means for receiving a first plurality of anchor markers for the first level and a second plurality of anchor markers for the second level, wherein each anchor point of the first plurality of anchor markers is associated with a corresponding anchor point of the second plurality of anchor markers for the second level; and means for deforming at least a portion of the first set of map data or the second set of map data to align anchor markers of the first plurality of anchor markers with corresponding anchor markers of the second plurality of anchor markers.

Additional embodiments of such a computing device further include means for calculating a deformation score that characterizes the deformation associated with aligning the anchor markers of the first plurality of anchor markers with the corresponding anchor markers of the second plurality of anchor markers; and means for adjusting the deformation to reduce the deformation score while maintaining at least a portion of the alignment when the deformation score is above a predefined threshold.

Additional embodiments of such a computing device may function where receiving the first plurality of anchor markers for the first level and the second plurality of anchor markers for the second level comprises: receiving at least one matched pair of first level and second level anchor points from a map management module of each mobile device of a plurality of crowdsourced mobile devices.

Another embodiment may be a non-transitory computer-readable medium comprising computer-readable instructions for map alignment, wherein the instructions, when executed by a processor, cause a device to: receive a first set of map data associated with a first level of a location; receive a second set of map data associated with a second level of the location; receive a first plurality of anchor markers for the first level and a second plurality of anchor markers for the second level, wherein each anchor point of the first plurality of anchor markers is associated with a corresponding anchor point of the second plurality of anchor markers for the second level; and deform at least a portion of the first set of map data or the second set of map data to align anchor markers of the first plurality of anchor markers with corresponding anchor markers of the second plurality of anchor markers.

Further examples of such an embodiment may function where the instructions further cause the device to: calculate a deformation score that characterizes the deformation associated with aligning the anchor markers of the first plurality of anchor markers with the corresponding anchor markers of the second plurality of anchor markers; and adjust the deformation to reduce the deformation score while maintaining at least a portion of the alignment when the deformation score is above a predefined threshold.

Further examples of such an embodiment may function where receiving the first plurality of anchor markers for the first level and the second plurality of anchor markers for the second level comprises: receiving at least one matched pair of first level and second level anchor points from a map management module of each mobile device of a plurality of crowdsourced mobile devices.

Further examples of such an embodiment may function where the instructions further cause the device to: display the first and second sets of map data in conjunction with anchor points and anchor lines as part of the anchor markers. Further examples of such an embodiment may function where the instructions further cause the device to: determine a position of the computing device and display the position of the computing device with the first and second sets of map data.

Additional embodiments of such a computing device may include means for displaying the first and second sets of map data in conjunction with anchor points and anchor lines as part of the anchor markers. Additional embodiments of such a computing device may include means for determining a position of the computing device and displaying the position of the computing device with the first and second sets of map data.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A is a map for a first level of a multi-level location according to one embodiment;

FIG. 1B is a map for a second level of a multi-level location according to one embodiment;

FIG. 2 describes a map of a multi-level location according to one embodiment;

FIG. 3 is a top down view map of a multi-level location showing two levels according to one embodiment;

FIG. 4 is a perspective view a map of a multi-level location showing two levels according to one embodiment;

FIG. 5 is one example of a mobile device for use with a potential embodiment;

FIG. 6 describes a method for presenting map data in accordance with one potential embodiment;

FIG. 7 describes a method for presenting map data in accordance with one potential embodiment;

FIG. 8 is one implementation of a computer device according to certain embodiments; and

FIG. 9 is one implementation of a networked computer system according to certain embodiments.

### DETAILED DESCRIPTION

Embodiments described herein include systems, methods, devices, and computer-readable media for map alignment to provide better positioning and navigation in multi-level venues.

One embodiment may use crowdsourced information where an application running on mobile devices allows a user to indicate matching anchor points, lines, or other characteristics across levels. Examples of such anchors may be walls, corners, or pillars which extend across multiple levels of a multi-level venue. This information may then be communicated from the mobile devices to a centralized server which may integrate the crowdsourced information and update venue maps. Another embodiment may involve a single mobile device that receives maps, accepts a user input identifying anchors, and then deforms the maps locally to match the anchor points.

For example, a user in a mall environment with two stories may receive two separate maps at a mobile device for two levels of the mall. A user interface may be presented to enable the user to identify points on the two maps that are directly above and below each other. This may be done automatically, or in response to a user recognizing a misalignment, and selecting an option to provide feedback on map alignment. The user may then provide inputs identifying map areas or points of interest such as exterior walls, multi-level pillars, escalators, elevators, or other such identifiable areas that should be aligned across levels. This user information may then be processed to ensure that no obvious errors were made by the user in identifying the alignment, and the map alignment may then be updated by deforming the maps for one or both levels to match the anchor points.

Floor maps for each level are usually created separately with GPS data, AB-based location data, known floor map information, etc. For example, floor maps may be created automatically from sensor data by a device traveling through the location. Although for indoor navigation on the same floor the misalignment errors discussed above do not cause problems, for cross-level and/or 3D positioning and navigation, well aligned multi-level maps will provide a better user navigation experience and will also give more accurate heat map models when access points are modeled across multiple levels.

The alignment errors created by this type of map creation are typically not linear. Therefore when the misalignments are identified, simple linear transformations are not effective for correcting the misalignment. Various examples of non-linear transformations such as the use of moving least squares transformation are described below. Such non-linear transformations of the maps may introduce other errors across a level, but the errors will typically be sufficiently small that correction of the alignment points will provide an improvement in overall multi-level map quality, and small enough to prevent confusion in positioning and navigation. Certain embodiments may additionally use checks or thresholds to limit or balance the amount of map deformation for any single level of map information. These non-linear transformations are also described herein as deformations, deformations of map information, deformations of map data and similar.

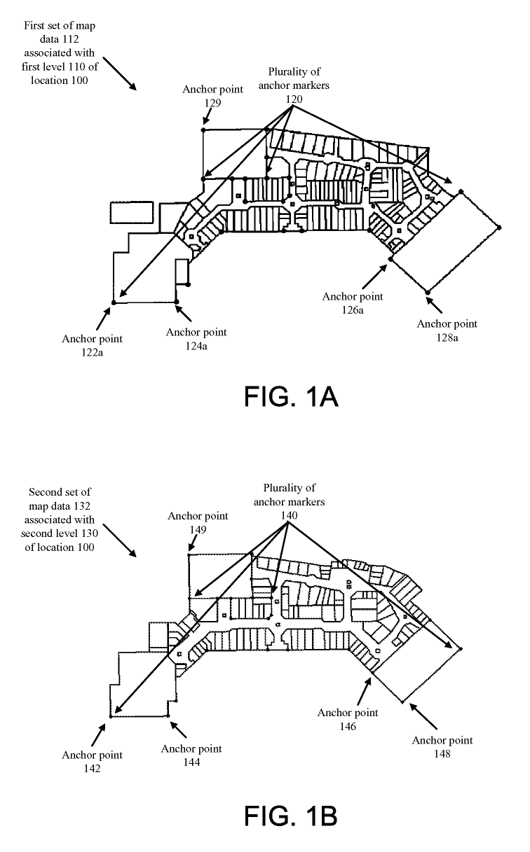

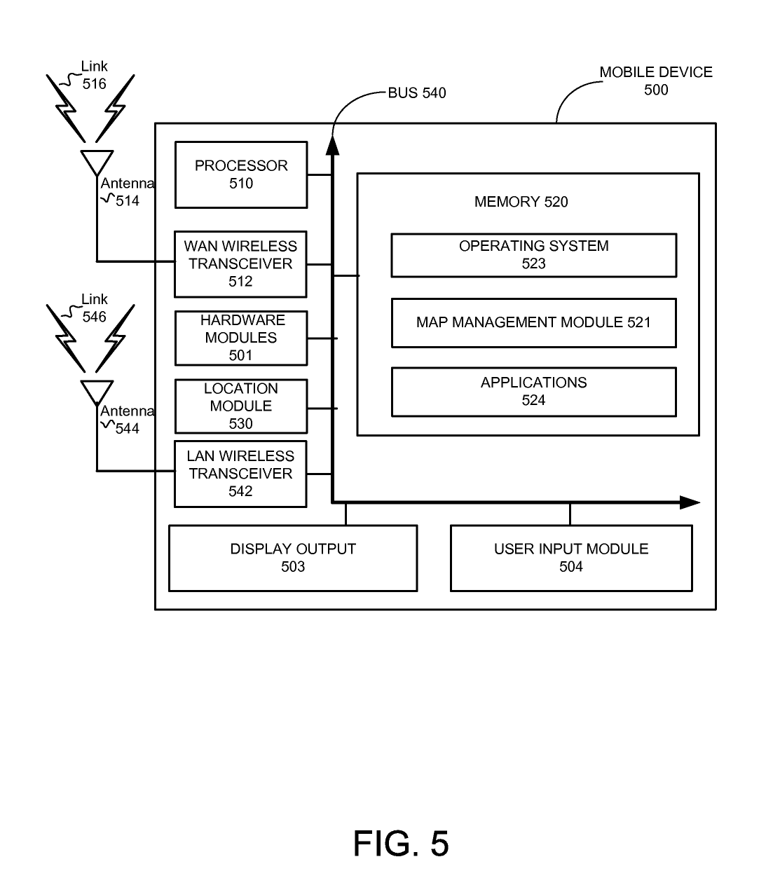

FIGS. 1A and 1B show map data for two levels of a multi-level location. As used herein, the term “location” refers to a venue, environment, area, building, stadium park, or any other open or closed space that may include multiple levels. It may also refer to combinations of any of the previous, or to locations comprising more than one of any or all of the previous. FIG. 1A shows first set of map data 112, which is associated with first level 110 of a location 100. Location 100 may, for example, be a mall or shopping area. Other examples could be a multi-story library, or any other such multi-story building or area. FIG. 1A further shows a plurality of anchor markers 120. This includes anchor points 122a, 124a, 126a, 128a, and 129. These anchor points may be created by a user interacting with a mobile device, as described below, especially with regard to mobile device 500 of FIG. 5. In alternative embodiments, anchor lines may be used, or any other such shape. For example, circles may be used to identify pillars that extend across multiple levels. Squares or rectangles may identify elevator shafts. Any free-drawn, two-dimensional shape may be used as an anchor, as long as there is an identifiable corresponding anchor on another level to use as a matching anchor.

FIG. 1B shows a second set of map data 132 associated with a second level 130 of the same location 100 from FIG. 1A. FIG. 1B shows a plurality of anchor markers 140, including anchor points 142, 144, 146, 148, and 149. These anchor points may be considered to be corresponding pair anchors for the anchor points of FIG. 1A. FIGS. 1A and 1B should make the matches apparent, with anchor point 122 matching anchor point 142, anchor point 124 matching anchor point 144, anchor point 126 matching anchor point 146, anchor point 128 matching anchor point 148, and anchor point 129 matching anchor point 149.

The match between these anchor points may be made based on a visual inspection of location 100. For example, external viewing of the building may make it apparent that anchor points 129 and 149 are at a corner of a two-story exterior wall. The anchors may thus be identified as part of user observation and input of anchors into a map management system. In many situations, a user may identify a large building with straight walls, and be able to identify that the corners of the first and second floor of a building should be aligned. Other points may be identified by a user as points or areas that not aligned in a map but should be. Entrance and exits in a two-story area that are directly above and below each other, elevator locations, stairs, escalators, and other such points may be identified by a user.

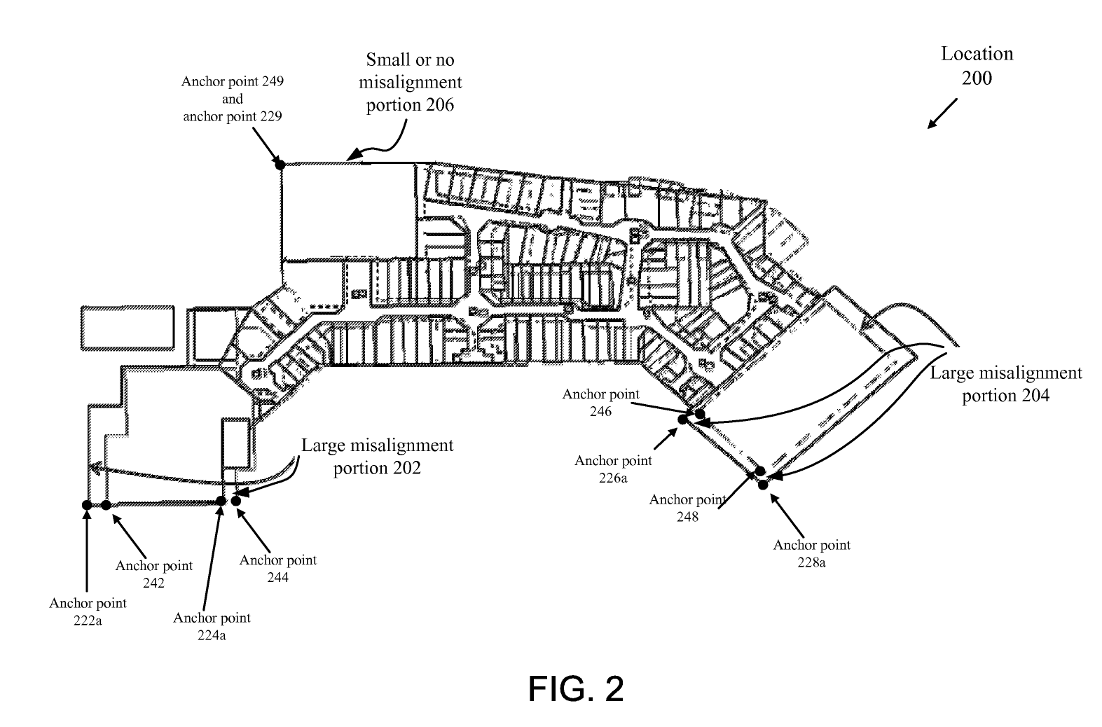

FIG. 2 shows an overlay of misaligned maps for a mall having first and second floors. Such misalignment may be caused by noise in collected data, errors in scaling, or any other such errors. The anchors of FIG. 2 may be seen to correspond to anchors of FIG. 1A and FIG. 1B with location 200 being similar to location 100. For example, anchor point 222a may correspond to anchor point 122a, and anchor point 142 may correspond to anchor point 242. Anchor points 222a, 224a, 226a, 228a, and 229 are associated with a first level of location 200. Anchor points 242, 244, 246, 248, and 249 are associated with the second level of location 200. Just as in FIGS. 1A and 1B, anchors 22Xa are associated with the corresponding anchors 24X. As shown in FIG. 2, however, various levels of misalignment are present. For example, anchor point 222a is offset from anchor point 242 in a horizontal direction, and anchor point 248 is offset from anchor point 228a in a vertical direction. The misalignment, however, is not consistent throughout the two map levels of location 200. This may be seen by the different types of misalignment in large misalignment portion 202, large misalignment portion 204, and small or no misalignment portion 206. Anchor points 248 and 228a are thus representing a user input identifying an error in map alignment, since anchor point 248 and anchor point 228a should be directly on top of each other when the maps are overlaid as shown in FIG. 2. In small or no misalignment portion 206, anchor points 249 and 229 are directly on top of each other, showing a correct alignment. The misalignment associated with pairs of anchors may then be used to deform either or both levels of map information to improve the alignment of the maps.

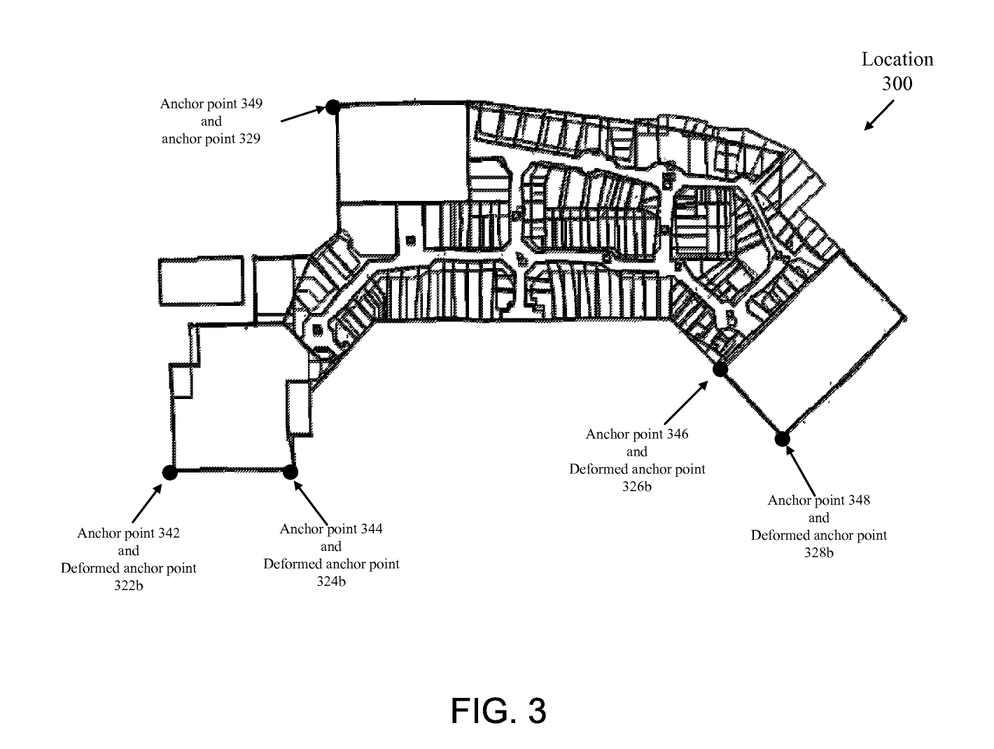

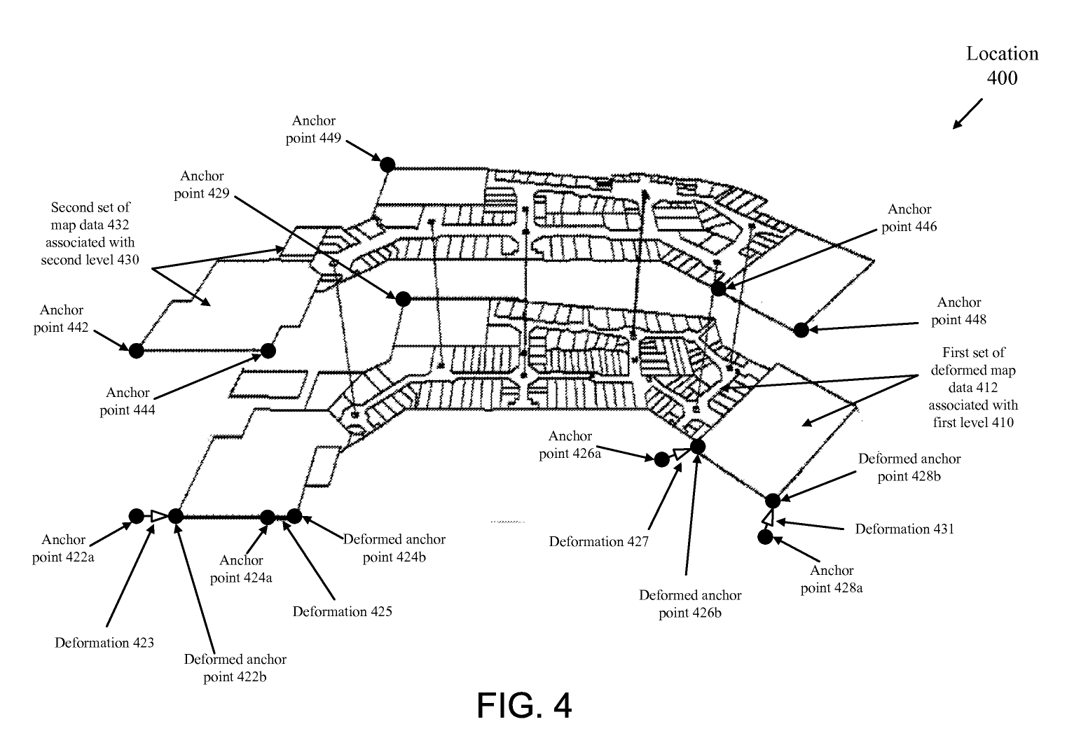

FIGS. 3 and 4 now show an example of two overlaid maps that have been aligned by deforming map information for a first level of a location 300 having a first set of deformed map data 312 associated with first level 310 and a second set of map data 332 associated with second level 330. Location 300 may be similar to locations 100 and 200 of FIGS. 1A, 1B, and 2. FIGS. 3 and 4 essentially then also show the two map levels overlaid just as shown in FIG. 2, with an adjustment to match the identified corresponding anchor points. Map adjustments may be made on anchor markers by moving the anchor markers to the correct alignment position while preserving original map topology as much as possible and minimizing the change of the overall layout of the map.

FIG. 3 shows overlaid map information for two levels of location 300. The overlay shows five pairs of anchor points which have been matched by deforming the map data of deformed map data 312 associated with first level 310. FIG. 3 thus shows anchor points for the first level which has been deformed including deformed anchor points 322b, 324b, 326b, 328b as well as anchor point 329. Each of these anchor points corresponds to an anchor point of the second level 330 of location 300, including, respectively, anchor points 342, 344, 346, 348, and 349. Although anchor point 329 is part of the deformed first level, anchor point 329 itself was not deformed because it was already aligned before the deformation process was implemented to deform the first level. This may be seen by anchor points 129, 149, 229 and 249 of FIGS. 1A, 1B, and 2 prior to any deformation of maps for similar locations 100 and 200.

FIG. 4 then shows an offset three-dimensional view of location 400, with map data 432 for second level 430 shown above map data 412 for first level 410. First level 410 anchor points 422a, 424a, 426a, 428a, and 429 are also shown with respective corresponding anchor points 442, 444, 446, 448, and 449. Anchor points for first level 310 are shown as point both pre- and post-deformation. Anchor points 422a, 424a, 426a, and 428a thus correspond to anchor points as originally received from a system or device used to identify corresponding anchor points. Similar to the misalignment shown in FIG. 2, anchor points 422a, 424a, 426a, and 428a are initially misaligned from respective corresponding anchor points 442, 444, 446, and 448 of second level 430. After a deformation process is used to align the pairs of matching anchor points, anchor points 422a, 424a, 426a, and 428a are shifted to new positions as shown by deformed anchor points 422b, 424b, 426b, and 428b by deformations 423, 425, 427, and 431.

In the embodiment illustrated by FIGS. 3 and 4, map data 412 for first level 410 is shown as deformed, with no change to map data 432 associated with second level 430. In alternative embodiments, both levels may be partially transformed to align corresponding anchors, or alternatively, map data 432 could be deformed with map data 412 left with no deformation. Further, in certain embodiments, thresholds may be implemented to prevent excessive deformation while aligning anchor points. In such embodiments, a deformation may be made to improve the alignment of anchor points, without entirely matching the anchors in an overlay. Alternatively, if a threshold is exceeded, a system may simply reject any deformation, and retain the original map data for levels with no deformation.

Additionally, while the embodiments described herein are representatively discussed with respect to two levels, alignments may be done for any number of levels. Such alignment may be done serially, with only a portion of the floors aligned in one process, and additional floors aligned during subsequent process steps. Alternatively, all floors may be aligned at one time, with any combination of deformed and non-deformed map data for various levels, depending on the particular deformation process used.

As discussed above, map adjustments may be made on anchor markers by moving the anchor markers to the correct alignment position, deforming the original map topology and minimizing the change of the overall layout of the multi-level map.

One potential method of deforming map information and aligning these anchors including anchor markers is to use a moving least square (MLS) method as described by THE APPROXIMATION POWER OF MOVING LEAST-SQUARES″, DAVID LEVIN, MATHEMATICS OF COMPUTATION; Volume 67, Number 224, October 1998, Pages 1517; “Image deformation using moving least squares” S Schaefer, T McPhail, J Warren-ACM Transactions on Graphics (TOG), 2006, which is hereby incorporated by reference for all purposes.

For such a deformation method using MLS, the adjustment is viewed as a function ƒ that maps points in the original map image to the adjusted map image. Applying the function ƒ to each point v in the original map image creates the adjusted map. For a map with a set of handle points pi where 1=1 to N, those are the points that the user would like to move to new positions qi. For ƒ to be useful for adjustment, it should satisfy the following properties:

1) Interpolation: For each handle point pi should map directly to qi under adjustment:

f(pi)=qi;

2) Smoothness: ƒ should produce smooth adjustment;
3) Identity: If the adjustment handles qi are the same as the pi, then ƒ should be the identity function;

qi=pi [symbol] f(pi)=pi.

While this is one potential method of aligning anchor markers, any other method that preserves the topology of each level as much as possible while aligning and scaling the levels may be used. Other examples include Cassowary constraint solvers or simplex constraint solvers.

Further, in certain embodiments associated with MLS, Cassowary, or simplex systems, the amount of deformation associated with the alignment of a pair of points may be associated with a score or other characterization of the amount of deformation. For example, if a user incorrectly associates anchor point 348 with anchor point 228b, the resulting deformation would present an unusable map if the points were actually matched to be on top of each other while maintaining a minimum deformation. Thresholds may be established for the amount of deformation allowed to be associated with each pair of anchors or with the overall deformation of map data. If excessive amounts of deformation are seen, the entire alignment process may be rejected. In alternative embodiments, rules may be established for allowing a portion of the deformation to partially align the points while avoiding excessive deformation of maps.

This enables the use of crowdsourcing information while maintaining filters for dealing with errors in user input, or the input of intentionally incorrect information by certain users that provide information to the crowdsourced system. In single user systems, these filters prevent a user from deforming maps beyond the ability of other integrated systems to deal with the deformations. For example, navigation and presentation systems may have errors when presented with excessively deformed maps.

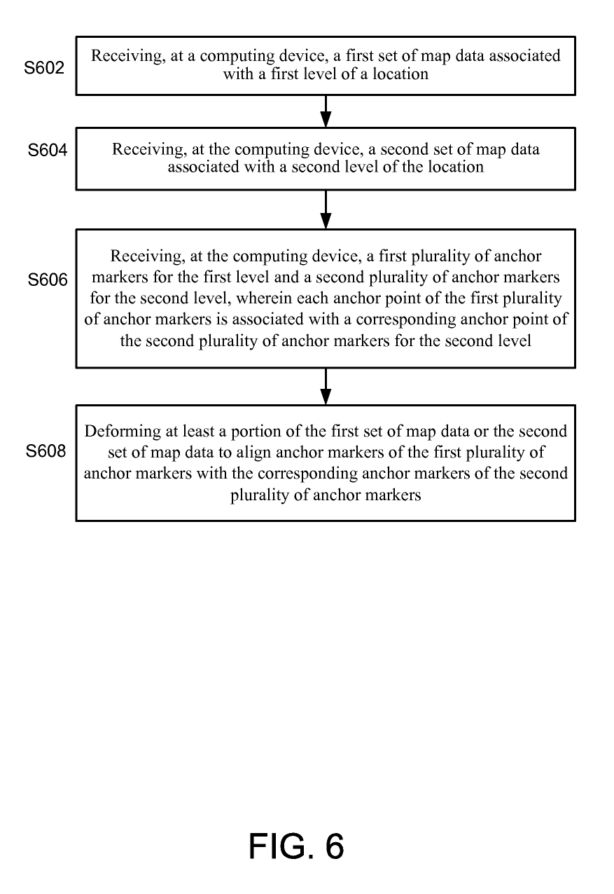

FIG. 5 now describes one potential implementation of a mobile device 500 according to certain embodiments. Mobile device 500 of FIG. 5 may be used to present map information such as map data 132 and map data 112 to a user, and may receive anchor information via a user input. Mobile device may either communicate anchor information to a centralized server computer for processing, or may perform map deformation locally to match corresponding anchor points from different levels. Additional details of such processes which may be initiated and managed by mobile device 500 using, for example, a map management module 521 are described below with respect to FIGS. 5-6.

In certain embodiments of mobile device 500, map level information may be received from links 516 or 546 and then stored in memory 520, either as part of an application 524, or in a non-transitory storage of memory 520. The information may then be used by various applications 524, including location applications or map management module 521, before being presented to a user on a display output 503. Such map information may additionally be analyzed, processed, and deformed locally using processor 510 in conjunction with a map management module 521, or may be communicated out via link 516 or 546 along with anchor information.

In the embodiment shown at FIG. 5, mobile device 500 includes said processor 510 configured to execute instructions for performing operations at a number of components and can be, for example, a general-purpose processor or microprocessor suitable for implementation within a portable electronic device. Processor 510 is communicatively coupled with a plurality of components within mobile device 500. To realize this communicative coupling, processor 510 may communicate with the other illustrated components across a bus 540. Bus 540 can be any subsystem adapted to transfer data within mobile device 500. Bus 540 can be a plurality of computer buses and include additional circuitry to transfer data.

Memory 520 may be coupled to processor 510. In some embodiments, memory 520 offers both short-term and long-term storage and may in fact be divided into several units. Memory 520 may be volatile, such as static random access memory (SRAM) and/or dynamic random access memory (DRAM), and/or non-volatile, such as read-only memory (ROM), flash memory, and the like. Furthermore, memory 520 can include removable storage devices, such as secure digital (SD) cards. Thus, memory 520 provides storage of computer-readable instructions, data structures, program modules, and other data for mobile device 500. In some embodiments, memory 520 may be distributed into different hardware modules.

In some embodiments, memory 520 stores a plurality of map management modules 521, which may be any number of applications 524. Application modules contain particular instructions to be executed by processor 510. In alternative embodiments, other hardware modules 501 may additionally execute certain applications 524 or parts of applications. In certain embodiments, memory 520 may additionally include secure memory, which may include additional security controls to prevent copying or other unauthorized access to secure information such as private or secure map information or private placement data which may be part of level, map, or object information.

In some embodiments, memory 520 includes an operating system 523. Operating system 523 may be operable to initiate the execution of the instructions provided by application modules and/or manage other hardware modules 501 as well as interfaces with communication modules which may use WAN wireless transceiver 512 and LAN wireless transceiver 542 to receive information from link 516 via antenna 514 and/or link 546 via antenna 544, respectively. Operating system 523 may be adapted to perform other operations across the components of mobile device 500, including threading, resource management, data storage control and other similar functionality.

In some embodiments, mobile device 500 includes a plurality of other hardware modules 501. Each of other hardware modules 501 is a physical module within mobile device 500. However, while each of hardware modules 501 is permanently configured as a structure, a respective one of hardware modules 501 may be temporarily configured to perform specific functions or temporarily activated. A common example is an application module that may track user movements using hardware modules 501 or location modules 530 which provide movement information and work with a map application to provide directions via a display output 503. A respective one of hardware modules 501 can be, for example, an accelerometer, a Wi-Fi transceiver, a satellite navigation system receiver (e.g., a GPS module), a pressure module, a temperature module, an audio output and/or input module (e.g., a microphone), a camera module, a proximity sensor, an alternate line service (ALS) module, a capacitive touch sensor, a near field communication (NFC) module, a Bluetooth transceiver, a cellular transceiver, a magnetometer, a gyroscope, an inertial sensor (e.g., a module the combines an accelerometer and a gyroscope), an ambient light sensor, a relative humidity sensor, or any other similar module operable to provide sensory output and/or receive sensory input. In some embodiments, one or more functions of the hardware modules 501 may be implemented in software. According to various embodiments, any number of such hardware modules 501 may provide information to map management module 521 or another application 524 in conjunction with map information which may be deformed according to various processes described herein in order to provide location and/or navigation services via mobile device 500.

Mobile device 500 may include a component such as wireless communication module which may integrate antenna 514 and wireless transceiver 512 with any other hardware, firmware, or software necessary for wireless communications. Such a wireless communication module may be configured to receive signals from various devices such data sources via networks and access points. In various embodiments, either of these systems bay be used to receive and send map information, as well as to receive or send anchor information.

In addition to other hardware modules 501 and applications 524 in memory 520, mobile device 500 may have a display module 503 and a user input module 504. Display module 503 graphically presents information from mobile device 500 to the user. This information may include map information that has been deformed by map management module 521 as part of any process described herein, or may be derived from one or more applications 524, one or more hardware modules 501, a combination thereof, or any other suitable means for resolving graphical content for the user (e.g., by operating system 523). Display module 503 can be a liquid crystal display (LCD) technology, light emitting polymer display (LPD) technology, or some other display technology. In some embodiments, display module 503 is a capacitive or resistive touch screen and may be sensitive to haptic and/or tactile contact with a user. In such embodiments, the display module 503 can comprise a multi-touch-sensitive display. Display output 503 may then be used to display the map information for a multi-level venue in conjunction with map management module 521.

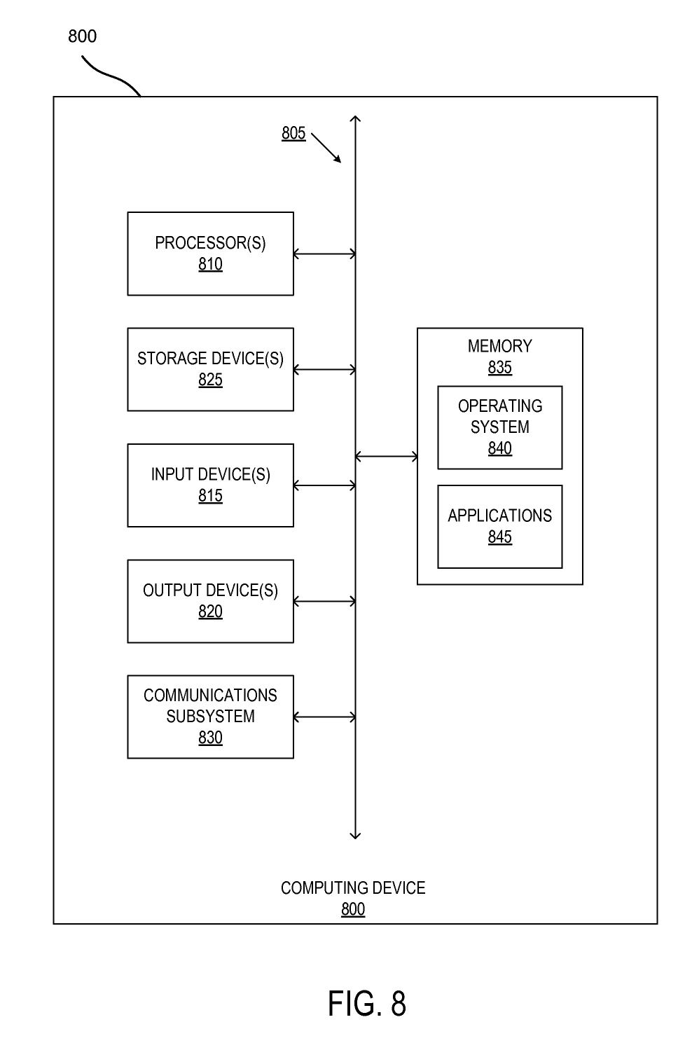

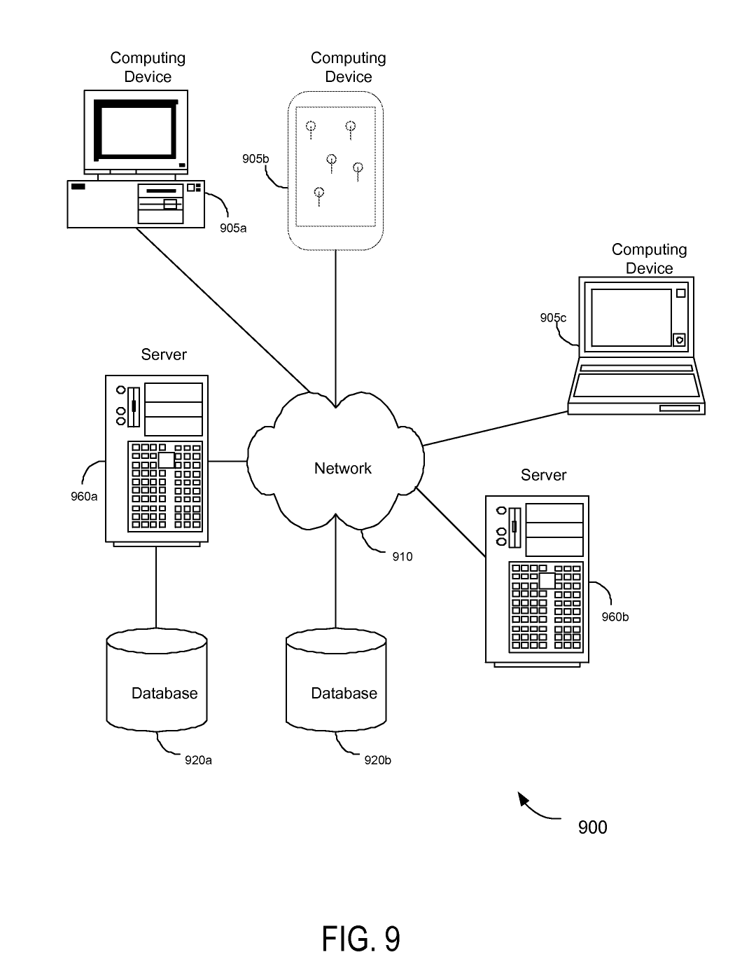

Additional potential embodiments of a mobile device may further comprise various portions of computing devices as are detailed below with respect to FIG. 8 and networks as detailed in FIG. 9.

FIGS. 5 and 6 show potential embodiments of methods in accordance with the innovations presented herein, including potential examples of methods for creating aligned map information that may be output via a device such as mobile device 500. FIG. 6 describes a method with a single computing device that receives map data and anchor information, and then uses that information within the computing device to align maps from different levels by deforming at least a portion of the map data. In various embodiments, the computing device may be a mobile device such as mobile device 500. In alternative embodiments, the computing device may be a server computer that is receiving anchor information from mobile devices.

As described by FIG. 6, S602 involves receiving, at a computing device, a first set of map data associated with a first level of a location. S604 then involves receiving, at the computing device, a second set of map data associated with a second level of the location. In various embodiments, this information may be received as part of a single communication providing multi-level map information, or this information may be received as separate communications.

S606 then involves receiving, at the computing device, a first plurality of anchor markers for the first level and a second plurality of anchor markers for the second level. In this embodiment, each anchor point of the first plurality of anchor markers is associated with a corresponding anchor point of the second plurality of anchor markers for the second level. As described above, this receiving process may be a user input to a mobile device, such as a touch screen or button selection input. Alternatively, this may be a wired or wireless data communication from another device. In S608, the method continues with deforming at least a portion of the first set of map data or the second set of map data to align anchor markers of the first plurality of anchor markers with the corresponding anchor markers of the second plurality of anchor markers.

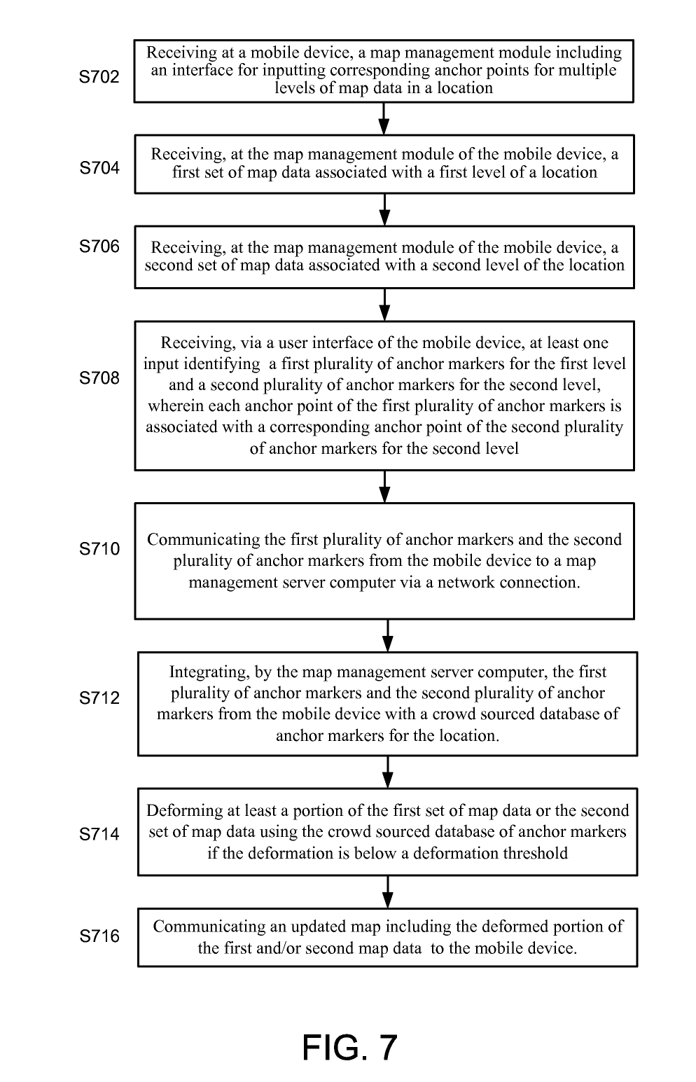

FIG. 7 describes another alternative according to the embodiments described herein. FIG. 7 particularly describes an embodiment where information is captured by a mobile device and communicated to a centralized server computer. The server computer then uses the information to deform maps in order to align different level maps for a location. The method of FIG. 7 begins in S702 with receiving at a mobile device, a map management module including an interface for inputting corresponding anchor points for multiple levels of map data in a location. This is essentially a download of an application that may function on a mobile device such as mobile device 500 of FIG. 5.

In S704-S708, the method continues in a manner similar to the method of FIG. 6. S704 involves receiving, at the map management module of the mobile device, a first set of map data associated with a first level of a location, and S706 involves receiving, at the map management module of the mobile device, a second set of map data associated with a second level of the location. In S708, the mobile device receives, via a user interface of the mobile device, at least one input identifying a first plurality of anchor markers for the first level and a second plurality of anchor markers for the second level, wherein each anchor point of the first plurality of anchor markers is associated with a corresponding anchor point of the second plurality of anchor markers for the second level.

In S710, a communication with a different device occurs, including communicating the first plurality of anchor markers and the second plurality of anchor markers from the mobile device to a map management server computer via a network connection. The map management server receives the information, and then continues in S712 by integrating at the map management server, the first plurality of anchor markers and the second plurality of anchor markers from the mobile device with a crowdsourced database of anchor markers for the location.

S714 continues by deforming, by the map management server computer, at least a portion of the first set of map data or the second set of map data using the crowdsourced database of anchor markers if the deformation is below a deformation threshold. After a map update occurs, the method may proceed to S716 by communicating an updated map including the deformed portion of the first and/or second map data to the mobile device. In various embodiments, map information may be communicated to any number of mobile devices or other devices. Further, map storage and distribution may be separated on a different computing device from deformation, such that the updated map may be pushed to a map server, and then communicated to devices only when requested by the devices. Alternatively, a system may keep track of which devices have copies of maps for a location, and automatically push deformed maps to devices when updates occur. Still further embodiments may analyze the level of change made to maps during a map deformation, and may only push maps out to devices when a certain level of change to the map is created by the deformation process.

In various embodiments, an alignment processes as described above may be triggered in a variety of different ways. In certain embodiments, anchor markers may be stored in conjunction with map data, and an alignment may be triggered whenever there is a request for a multi-floor may. This may occur when the access point configuration on a user's current floor is not sufficient for positioning, where the system needs access points on an adjacent floor to help with positioning. In other embodiments, this alignment may be triggered when a user is in a transitional region, such as in an escalator, and is requesting a view of a current location on a mobile device. In other embodiments, a user may initiate an interface selection for an alignment when the user identifies a misalignment in a multi-level map, or whenever a user desires an alignment. In other embodiments, rather than the trigger being an action or detection at a local mobile device, a trigger may occur on a remote server than stores map data. For example, in crowdsourced embodiments, an alignment may be triggered when a certain threshold of anchor markers are received, or when a certain number of users submit anchor markers. Alternatively, an alignment may be triggered when anchor markers are received that meet a threshold for potential misalignment. This may occur when a certain number of anchor markers conflict in the information that they provide.

In various embodiments described herein, alignment may be initiated by a computing system when certain triggers are detected. For example, in one embodiment, corresponding anchoring points may be stored in maps or a separate file as the metadata of a venue. An alignment may be triggered when there is a request for a multi-floor map, which may happen when the AP configuration on a user's current floor is not sufficient for positioning, when the system needs APs on the adjacent floor to help, or when the user is on a transitional region such as an escalator and requests a view of a current location on his mobile device. In alternate embodiments, a user may initiate an alignment via a mobile device's user interface. In still further embodiments, other triggers may be used. Any such trigger may initiate any alignment method described herein.

FIG. 8 illustrates an example of a computing system in which one or more embodiments may be implemented. For example, in certain embodiments, the system of FIG. 8 may function as an alternative to mobile device 500. In further embodiments, the system of FIG. 8 may serve as a server computer which is in communication with one or more mobile devices such as mobile device 500 of FIG. 5. In further embodiments, a network that delivers map and/or anchor data may be implemented using computing systems such as those described by FIG. 8. Additionally, any computing device as described herein may include any combination of components. For example, any alternatives to mobile device 500 may be structured according to the embodiment of computing device 800 of FIG. 8 or any element of computing device 800 in combination with other elements. In various embodiments then, elements or components of a system may be structured as any functional mix of computing elements described herein, such that any function or functions of any device described herein may be implemented by multiple computing devices similar to computing device 800, or any combination of elements of computing device 800.

FIG. 8 provides a schematic illustration of one embodiment of a computing device 800 that can perform the methods provided by various other embodiments such as the embodiments described by FIGS. 5 and 6 as described herein. FIG. 8 is meant only to provide a generalized illustration of various components, any or all of which may be utilized as appropriate. FIG. 8, therefore, broadly illustrates how individual system elements may be implemented in a relatively separated or relatively more integrated manner, and describes elements that may implement specific methods according to embodiments of the invention when, for example, controlled by computer-readable instructions from a non-transitory computer-readable storage device such as storage device(s) 825.

The computing device 800 is shown comprising hardware elements that can be electrically coupled via a bus 805 (or may otherwise be in communication, as appropriate). The hardware elements may include one or more processors 810, including without limitation one or more general-purpose processors and/or one or more special-purpose processors (such as digital signal processing chips, graphics acceleration processors, and/or the like); one or more input devices 815, which can include without limitation a mouse, a keyboard and/or the like; and one or more output devices 820, which can include without limitation a display device, a printer and/or the like. These elements may be used to communicate and deform maps using anchor points, and to display resulting map information via an output display using processors 810 to perform the calculations that are part of such transformations of map data.

The computing device 800 may further include (and/or be in communication with) one or more non-transitory storage devices 825, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like. The particular instructions which may define a specific embodiment of map transformation and merging may thus be stored in such non-transitory storage devices and used by one or more processors 810 to cause a computing device 800 to perform an analysis of map information and deformations, and to perform deformations on map information.

The computing device 800 might also include a communications subsystem 830, which can include without limitation a modem, a network card (wireless or wired), an infrared communication device, a wireless communication device and/or chipset (such as a Bluetooth®¹ device, a 702.11 device, a Wi-Fi device, a WiMax device, cellular communication facilities, etc.), and/or similar communication interfaces. The communications subsystem 830 may permit data to be exchanged with a network (such as the network described below, to name one example), other computer systems, and/or any other devices described herein. A mobile device such as mobile device 500 may thus include other communication subsystems in addition to those including wireless transceiver 512 and LAN wireless transceiver 542.

In many embodiments, the computing device 800 will further comprise a non-transitory working memory 835, which can include a RAM or ROM device, as described above. The computing device 800 also can comprise software elements, shown as being currently located within the working memory 835, including an operating system 840, device drivers, executable libraries, and/or other code, such as one or more applications 845, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods for merging maps.

A set of these instructions and/or code might be stored on a computer-readable storage medium, such as the storage device(s) 825 described above. In some cases, the storage medium might be incorporated within a computer system, such as computing device 800. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computing device 800 and/or might take the form of source and/or installable code, which, upon compilation and/or installation on the computing device 800 (e.g., using any of a variety of generally available compilers, installation programs, compression/decompression utilities, etc.) then takes the form of executable code. Map management module 521 may thus be executable code as described herein.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, controls for sensors such as touch screens, cameras, accelerometers, magnetometers, gyroscopes, or other such modules may be implemented as hardware, software, or firmware within a computing device 800. An activity selection subsystem configured to provide some or all of the features described herein relating to the selection of anchor points for map information of a particular level of a location and such subsystems may comprise hardware and/or software as part of such components. Such hardware and/or software may be specialized (e.g., an application-specific integrated circuit (ASIC), a software method, etc.), or generic (e.g., processor(s) 810, executing applications 845 which may, for example, implement any module within memory 520, etc.) Further, connection to other computing devices such as network input/output devices may be employed in order to implement any process including anchor selection and/or map deformation in a distributed fashion using components remotely located from each other but connected via a network.

The terms “machine-readable medium” and “computer-readable medium,” as used herein, refer to any medium that participates in providing data that causes a machine to operate in a specific fashion. In an embodiment implemented using the computing device 800, various computer-readable media might be involved in providing instructions/code to processor(s) 810 for execution and/or might be used to store and/or carry such instructions/code (e.g., as signals). In many implementations, a computer-readable medium is a physical and/or tangible storage medium. Such a medium may take many forms, including but not limited to, non-volatile media, non-transitory media, volatile media, and transmission media. Non-volatile media include, for example, optical and/or magnetic disks, such as the storage device(s) 825. Volatile media include, without limitation, dynamic memory, such as the working memory 835. Transmission media include, without limitation, coaxial cables, copper wire and fiber optics, including the wires that comprise the bus 805, as well as the various components of the communications subsystem 830 (and/or the media by which the communications subsystem 830 provides communication with other devices).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code. Any such memory may function as memory 520 or as secure memory if structured to maintain security of stored content.

The communications subsystem 830 (and/or components thereof) generally will receive the signals, and the bus 805 then might carry the signals (and/or the data, instructions, etc. carried by the signals) to the working memory 835, from which the processor(s) 810 retrieves and executes the instructions. The instructions received by the working memory 835 may optionally be stored on a non-transitory storage device 825 either before or after execution by the processor(s) 810.

In various embodiments as described herein, computing devices may be networked in order to communicate information. For example, mobile device 500 may be networked to receive information as described above. Additionally, each of these elements may engage in networked communications with other devices such as web servers, databases, or computers which provide access to information to enable applications via network, including the anchor selection and map deformation process described herein.

FIG. 9 illustrates a schematic diagram of a system 900 of networked computing devices that can be used in accordance with various embodiments to enable systems such as system 900 or other systems that may implement map merging. In various embodiments, elements of system 900 may function to collect anchor information, to process map information with pairs of anchor information, to deform map information for multi-level locations, and to provide the deformed map information to devices for use by a user.

The system 900 can include one or more user computing devices 905. The user computing devices 905 can be general purpose personal computers (including, merely by way of example, personal computers and/or laptop computers running any appropriate flavor of Microsoft® Windows®² and/or Mac OS®³ operating systems) and/or workstation computers running any of a variety of commercially-available UNIX®⁴ or UNIX-like operating systems. These user computing devices 905 can also have any of a variety of applications, including one or more applications configured to perform methods of the invention, as well as one or more office applications, database client and/or server applications, and web browser applications. Alternatively, the user computing devices 905 can be any other electronic device, such as a thin-client computer, Internet-enabled mobile telephone, and/or personal digital assistant (PDA), capable of communicating via a network (e.g., the network 910 described below) and/or displaying and navigating web pages or other types of electronic documents. Although the exemplary system 900 is shown with three user computing devices 905a-c, any number of user computing devices can be supported.

Certain embodiments of the invention operate in a networked environment, which can include a network 910. The network 910 can be any type of network familiar to those skilled in the art that can support data communications using any of a variety of commercially-available protocols, including, without limitation, TCP/IP, SNA, IPX, AppleTalk® ³, and the like. Merely by way of example, the network 910 can be a local area network (“LAN”), including, without limitation, an Ethernet network, a Token-Ring network and/or the like; a wide-area network (WAN); a virtual network, including, without limitation, a virtual private network (“VPN”); the Internet; an intranet; an extranet; a public switched telephone network (“PSTN”); an infrared network; a wireless network, including, without limitation, a network operating under any of the IEEE 802.11 suite of protocols, the Bluetooth protocol known in the art, and/or any other wireless protocol; and/or any combination of these and/or other networks. Network 910 may include access points for enabling access to network 910 by various computing devices.

Embodiments of the invention can include one or more server computers 960. Each of the server computers 960 may be configured with an operating system, including, without limitation, any of those discussed above, as well as any commercially (or freely) available server operating systems. Each of the server computers 960 may also be running one or more applications, which can be configured to provide services to one or more user computing devices 905 and/or other server computers 960. For example, in one potential embodiment, server 960a may run a first map application that provides a first map to mobile device 500 and server 960b may run a second application that provides a second map to mobile device 500. Mobile device 500 may then create anchor information with user input and deform the maps locally to match the anchor information for the different maps showing different levels of a location, or mobile device 500 may communicate the map information with the anchor information back to a server for processing.

Merely by way of example, one of the server computers 960 may be a web server, which can be used, merely by way of example, to process requests for web pages or other electronic documents from user computing devices 905. The web server can also run a variety of server applications, including HTTP servers, FTP servers, CGI servers, database servers, Java® ⁵ servers, and the like. In some embodiments of the invention, the web server may be configured to serve web pages that can be operated within a web browser on one or more of the user computing devices 905 to perform methods of the invention. Such servers may be associated with particular IP addresses, or may be associated with modules having a particular URL, and may thus store secure navigation modules which may interact with a mobile device such as mobile device 500 to provide secure indications of geographic points as part of location services provided to mobile device 500.

In accordance with further embodiments, one or more server computers 960 can function as a file server and/or can include one or more of the files (e.g., application code, data files, etc.) necessary to implement methods of various embodiments incorporated by an application running on a user computing device 905 and/or another server computer 960. Alternatively, as those skilled in the art will appreciate, a file server can include all necessary files, allowing such an application to be invoked remotely by a user computing device 905 and/or server computer 960. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 920. In one embodiment, a database 920 may store anchor information that has been crowdsourced from many different mobile devices. When new information is received, analysis may be performed to determine if the anchor information in database 920 necessitates a map deformation to align anchor information. The location of the database(s) 920 is discretionary: merely by way of example, a database 920a might reside on a storage medium local to (and/or resident in) a server 960a (and/or a user computing device 905). Alternatively, a database 920b can be remote from any or all of the user computing devices 905 or server computers 960, so long as the database 920b can be in communication (e.g., via the network 910) with one or more of these. In a particular set of embodiments, a database 920 can reside in a storage-area network (“SAN”) familiar to those skilled in the art. (Likewise, any necessary files for performing the functions attributed to the user computing devices 905 or server computers 960 can be stored locally on the respective computer and/or remotely, as appropriate.) In one set of embodiments, the database 920 can be a relational database, such as an Oracle® ⁵ database, that is adapted to store, update, and retrieve data in response to SQL-formatted commands. The database might be controlled and/or maintained by a database server, as described above, for example. Such databases may store information relevant to levels of security, determining which users may access certain levels of security, determining which map details may be included in certain maps of a security level, or any other such details which may be used as part of location assistance or location access data. Location data which may be sensitive, such as indications of points associated with a particular mobile device, may have associated security while crowdsourced data, which includes indications of pluralities of points which cannot be associated with a particular device, may have lower security levels.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner.

Specific details are given in the description to provide a thorough understanding of the embodiments. However, embodiments may be practiced without certain specific details. For example, well-known circuits, processes, algorithms, structures, and techniques have been mentioned without unnecessary detail in order to avoid obscuring the embodiments. This description provides example embodiments only, and is not intended to limit the scope, applicability, or configuration of various embodiments. Rather, the preceding description of the embodiments will provide those skilled in the art with an enabling description for implementing embodiments. Various changes may be made in the function and arrangement of elements without departing from the spirit and scope of various embodiments.

Also, some embodiments were described as processes depicted in a flow with process arrows. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Additionally, the above elements may merely be a component of a larger system, wherein other rules may take precedence over or otherwise modify the application's various embodiments, and any number of steps may be undertaken before, during, or after the elements of any embodiment are implemented.

Having described several embodiments, it will therefore be clear to a person of ordinary skill that various modifications, alternative constructions, and equivalents may be used without departing from the spirit of the disclosure.

### APPENDIX TO THE SPECIFICATION

¹ The “Bluetooth” word mark and logos are registered trademarks owned by Bluetooth SIG, Inc. Other trademarks and trade names are those of their respective owners.
² “Microsoft” and “Windows” are either registered trademarks or trademarks of Microsoft Corporation in the United States and/or other countries.
³ “Mac OS” and “AppleTalk” are registered trademarks of Apple, Inc., registered in the U.S. and other countries.
⁴ “UNIX” is a registered trademark of The Open Group.
⁵ “Java” and “Oracle” are registered trademarks of Oracle and/or its affiliates. Other names may be trademarks of their respective owners.

What is claimed is:

1. A method for map alignment comprising:
receiving, at a computing device, a first set of map data associated with a first level of a location;
receiving, at the computing device, a second set of map data associated with a second level of the location;
receiving, at the computing device, a first plurality of anchor markers for the first level and a second plurality of anchor markers for the second level, wherein each anchor point of the first plurality of anchor markers is associated with a corresponding anchor point of the second plurality of anchor markers for the second level; and
deforming at least a portion of the first set of map data or the second set of map data to align anchor markers of the first plurality of anchor markers with corresponding anchor markers of the second plurality of anchor markers.

2. The method of claim 1 wherein deforming at least the portion of the first set of map data or the second set of map data comprises:
(a) moving the first plurality of anchor markers to new positions; and
(b) moving data points in the portion of the first set of map data according to a moving least square (MLS) criteria, given new positions of the anchor markers of the first plurality of anchor markers.

3. The method of claim 1 wherein deforming at least the portion of the first set of map data or the second set of map data comprises:
(a) moving each anchor point of the first plurality of anchor markers a portion of a distance from an initial position to a position matching the corresponding anchor point of the second plurality of anchor markers; and
(b) moving data points in the portion of the first set of map data according to a simplex constraint criterion,
wherein the moving of each anchor point and the moving data points are jointly optimized to maximize the portion of the distance from the initial position to the position matching the corresponding anchor point and to minimize the moving of data points in the portion of the first set of map data.

4. The method of claim 1 further comprising:
calculating a deformation score that characterizes the deformation associated with aligning the anchor markers of the first plurality of anchor markers with the corresponding anchor markers of the second plurality of anchor markers.

5. The method of claim 4 further comprising:
rejecting the deformation when the deformation score is beyond a predefined threshold.

6. The method of claim 4 further comprising:
adjusting the deformation to reduce the deformation score while maintaining at least a portion of the alignment when the deformation score is above a predefined threshold.

7. The method of claim 1 wherein receiving the first plurality of anchor markers for the first level and the second plurality of anchor markers for the second level comprises:
presenting an image of the first level to a user on a display of the computing device;
receiving a user input identifying a first anchor point on the first level;
presenting an image of the second level to the user on the display of the computing device; and
receiving a user input identifying a second anchor point on the first level that corresponds to the first anchor point.

8. The method of claim 1 wherein receiving the first plurality of anchor markers for the first level and the second plurality of anchor markers for the second level comprises:
receiving at least one matched pair of first level and second level anchor points from a map management module of each mobile device of a plurality of crowdsourced mobile devices.

9. The method of claim 1 wherein the anchor markers comprise anchor points.

10. The method of claim 9 wherein the anchor markers further comprise anchor lines.

11. A computing device with map alignment functionality, the computing device comprising:
a memory;
a processor coupled to the memory that executes instructions from the memory to:
receive a first set of map data associated with a first level of a location;
receive a second set of map data associated with a second level of the location;
receive a first plurality of anchor markers for the first level and a second plurality of anchor markers for the second level, wherein each anchor point of the first plurality of anchor markers is associated with a corresponding anchor point of the second plurality of anchor markers for the second level; and
deform at least a portion of the first set of map data or the second set of map data to align anchor markers of the first plurality of anchor markers with corresponding anchor markers of the second plurality of anchor markers.

12. The computing device of claim 11 wherein deforming at least a portion of the first set of map data or the second set of map data comprises:
(a) moving the anchor markers of the first plurality of anchor markers to new positions; and
(b) moving data points in the portion of the first set of map data according to a moving least square (MLS) criterion, given new positions of the anchor markers of the first plurality of anchor markers.

13. The computing device of claim 11 wherein deforming at least a portion of the first set of map data or the second set of map data comprises:
(a) moving each anchor point of the first plurality of anchor markers a portion of a distance from an initial position to a position matching the corresponding anchor point of the second plurality of anchor markers; and
(b) moving data points in the portion of the first set of map data according to a simplex constraint criterion,
wherein the moving each anchor point and the moving data points are jointly optimized to maximize the portion of the distance from the initial position to the position matching the corresponding anchor point and to minimize the moving of data points in the portion of the first set of map data.

14. The computing device of claim 11 wherein the processor further:
calculates a deformation score that characterizes the deformation associated with aligning the anchor markers of the first plurality of anchor markers with the corresponding anchor markers of the second plurality of anchor markers.

15. The computing device of claim 14 wherein the processor further:
rejects the deformation when the deformation score is beyond a predefined threshold.

16. A non-transitory computer-readable medium comprising computer-readable instructions for map alignment, wherein the instructions, when executed by a processor, cause a device to:
receive a first set of map data associated with a first level of a location;
receive a second set of map data associated with a second level of the location;
receive a first plurality of anchor markers for the first level and a second plurality of anchor markers for the second level, wherein each anchor point of the first plurality of anchor markers is associated with a corresponding anchor point of the second plurality of anchor markers for the second level; and
deform at least a portion of the first set of map data or the second set of map data to align anchor markers of the first plurality of anchor markers with corresponding anchor markers of the second plurality of anchor markers.

17. The non-transitory computer-readable instruction medium of claim 16 wherein the instructions further cause the device to:
calculate a deformation score that characterizes the deformation associated with aligning the anchor markers of the first plurality of anchor markers with the corresponding anchor markers of the second plurality of anchor markers; and
adjust the deformation to reduce the deformation score while maintaining at least a portion of the alignment when the deformation score is above a predefined threshold.

18. The non-transitory computer-readable instruction medium of claim 16 wherein receiving the first plurality of anchor markers for the first level and the second plurality of anchor markers for the second level comprises:
receiving at least one matched pair of first level and second level anchor points from a map management module of each mobile device of a plurality of crowdsourced mobile devices.

19. The non-transitory computer-readable instruction medium of claim 16 wherein the instructions further cause the device to:
display the first and second sets of map data in conjunction with anchor points and anchor lines as part of the anchor markers.

20. The non-transitory computer-readable instruction medium of claim 19 wherein the instructions further cause the device to:
determine a position of the computing device and displaying the position of the computing device with the first and second sets of map data.
